(19) United States
(12) Patent Application Publication
(10) Pub. No.: US 2026/0302077 A1
(43) Pub. Date: Oct. 1, 2026

(54) MULTILAYER ELECTRONIC COMPONENT

(71) Applicant: SAMSUNG ELECTRO-MECHANICS CO., LTD., Suwon-si (KR)

(72) Inventors: Da Eun KIM, Suwon-si (KR); Sang Yeop KIM, Suwon-si (KR)

(73) Assignee: SAMSUNG ELECTRO-MECHANICS CO., LTD., Suwon-si (KR)

(21) Appl. No.: 19/547,119

(22) Filed: Feb. 23, 2026

(30) Foreign Application Priority Data
Mar. 27, 2025 (KR) 10-2025-0039511

(51) Int. Cl. H01G 4/30; H01G 4/012; H01G 4/232

(52) U.S. Cl. CPC H01G 4/30; H01G 4/012; H01G 4/232

(57) ABSTRACT

A multilayer electronic component includes a body including a laminate in which a dielectric layer and an internal electrode are stacked in a first direction, and a cover portion disposed on each of a plurality of surfaces of the laminate opposing each other in the first direction, the body including first and second surfaces opposing in the first direction, third and fourth surfaces connected to the first and second surfaces and opposing in a second direction, and fifth and sixth surfaces connected to the first, second, third, and fourth surfaces and opposing in a third direction, and an external electrode disposed on the third and fourth surfaces and connected to the internal electrode. The cover portion includes second regions adjacent to the third or fourth surfaces, and a first region disposed between the second regions, and an average hardness of the second regions is greater than the first region.

### CROSS-REFERENCE TO RELATED APPLICATION(S)

This application claims benefit of priority to Korean Patent Application No. 10-2025-0039511 filed on Mar. 27, 2025 in the Korean Intellectual Property Office, the disclosure of which is incorporated herein by reference in its entirety.

### TECHNICAL FIELD

The present disclosure relates to a multilayer electronic component.

Multilayer ceramic capacitors (MLCCs), a type of multilayer electronic component, are chip-shaped capacitors mounted on the printed circuit boards of various electronic products, for example, video devices such as Liquid Crystal Displays (LCD) and Plasma Display Panels (PDP), computers, smartphones, mobile phones, and infotainment systems, to charge or discharge electricity therein or therefrom.

MLCCs may include a cover portion and a side margin portion, which protect the internal electrodes from damage due to physical or chemical stress.

Generally, the cover portion and side margin portion undergo a sintering process, which may result in uneven stress across the area. As a result, the regions of the cover portion and side margin portion, adjacent to the surface of the body where the internal electrode is exposed, may have reduced toughness, increasing the possibility of chipping.

Because such chipping may cause a decrease in the moisture resistance reliability of the MLCC, there is a need for structural improvement of the MLCC that may reduce the frequency of chipping in regions of the cover portion and side margin portion adjacent to the surface of the body where the internal electrode is exposed.

### SUMMARY

An aspect of the present disclosure is to reduce the frequency of chipping in a region of a cover portion adjacent to a body surface where an internal electrode is exposed.

An aspect of the present disclosure is to reduce the frequency of chipping in a region of a side margin portion adjacent to a body surface where an internal electrode is exposed.

According to an aspect of the present disclosure, a multilayer electronic component includes a body including a laminate in which a dielectric layer and an internal electrode are stacked in a first direction, and a cover portion disposed on each of a plurality of surfaces of the laminate opposing each other in the first direction, the body including a first surface and a second surface opposing each other in the first direction, a third surface and a fourth surface connected to the first surface and the second surface and opposing each other in a second direction, and a fifth surface and a sixth surface connected to the first surface, the second surface, the third surface, and the fourth surface and opposing each other in a third direction; and an external electrode disposed on each of the third surface and the fourth surface and connected to the internal electrode. The cover portion includes second regions adjacent to the third surface or the fourth surface, and a first region disposed between the second regions, and an average hardness of the second regions is greater than an average hardness of the first region.

According to an aspect of the present disclosure, a multilayer electronic component includes a body including a laminate in which a dielectric layer and an internal electrode are stacked in a first direction, and a side margin portion disposed on each of a plurality of surfaces of the laminate opposing each other in a third direction, the body including a first surface and a second surface opposing each other in the first direction, a third surface and a fourth surface connected to the first surface and the second surface and opposing each other in a second direction, and a fifth surface and a sixth surface connected to the first surface, the second surface, the third surface, and the fourth surface and opposing each other in the third direction; and an external electrode disposed on each of the third surface and the fourth surface and connected to the internal electrode. The side margin portion includes fourth regions adjacent to the third surface or the fourth surface, and a third region disposed between the fourth regions, and an average hardness of the fourth regions may be greater than an average hardness of the third region.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment;

FIG. 2 schematically illustrates a cross-sectional view taken along line I-I′ of FIG. 1;

FIG. 3 schematically illustrates a cross-sectional view taken along line II-II′ of FIG. 1;

FIG. 4 schematically illustrates a cross-sectional view taken along line III-III′ of FIG. 1;

FIG. 5 schematically illustrates a cross-sectional view taken along line IV-IV′ of FIG. 1;

FIG. 6 schematically illustrates a perspective view of a body according to an embodiment; and

FIG. 7 is a graph showing the hardness of a cover portion and a side margin portion for each position according to an embodiment.

### DETAILED DESCRIPTION

Hereinafter, embodiments will be described with reference to detailed embodiments and the attached drawings. However, the embodiments may be modified in various other forms, and the scope of the present disclosure is not limited to the embodiments described below. Furthermore, the embodiments are provided to more fully explain the present disclosure to those skilled in the art. Therefore, the shapes and sizes of elements in the drawings may be exaggerated for clarity, and elements indicated by the same reference numerals in the drawings are identical elements.

In addition, to clearly describe the present disclosure, parts irrelevant to the description are omitted. The size and thickness of each component shown in the drawings are arbitrarily indicated for convenience of explanation. Therefore, the present disclosure is not necessarily limited to that shown. Furthermore, components with identical functions within the scope of the same concept are described using the same reference numerals. Furthermore, throughout the specification, when a part is referred to as “including” a component, this does not exclude other components, but rather implies the inclusion of other components, unless otherwise stated.

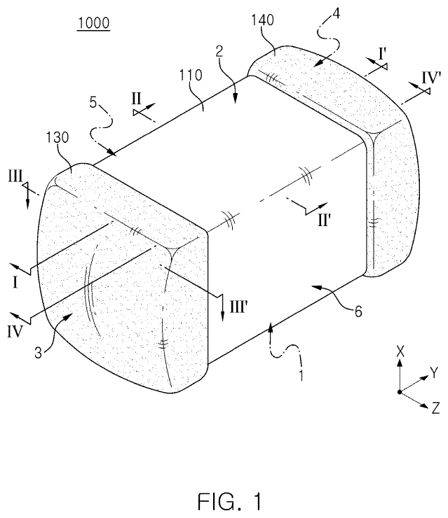

FIG. 1 schematically illustrates a perspective view of a multilayer electronic component according to an embodiment.

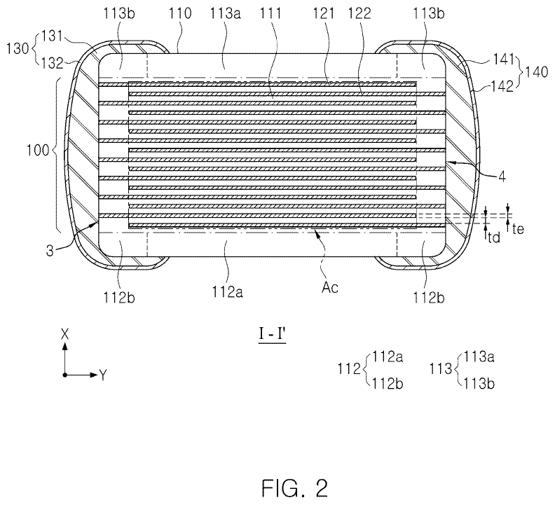

FIG. 2 schematically illustrates a cross-sectional view taken along line I-I′ of FIG. 1.

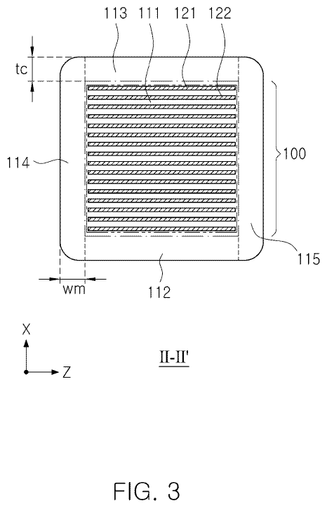

FIG. 3 schematically illustrates a cross-sectional view taken along line II-II′ of FIG. 1.

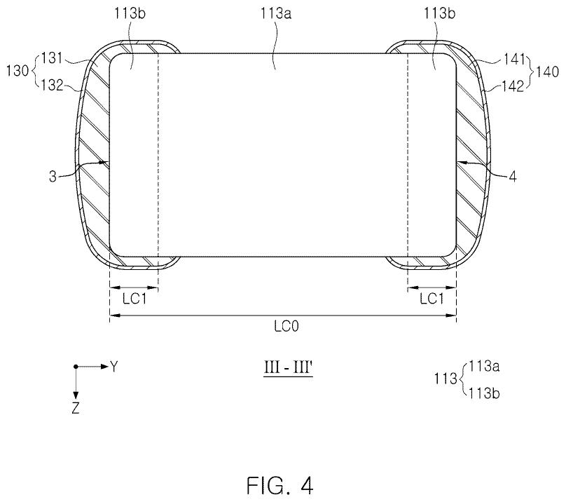

FIG. 4 schematically illustrates a cross-sectional view taken along line III-III′ of FIG. 1.

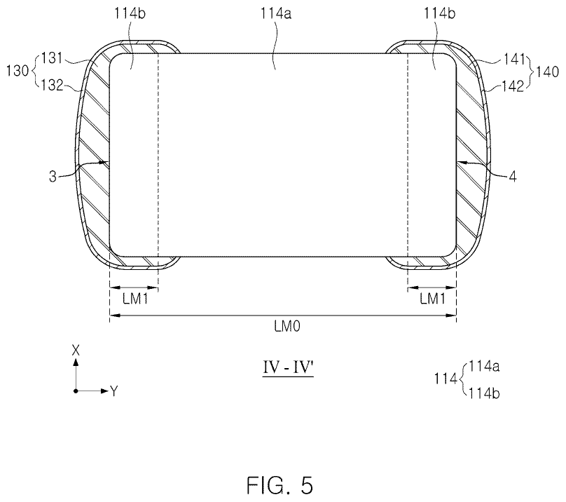

FIG. 5 schematically illustrates a cross-sectional view taken along line IV-IV′ of FIG. 1.

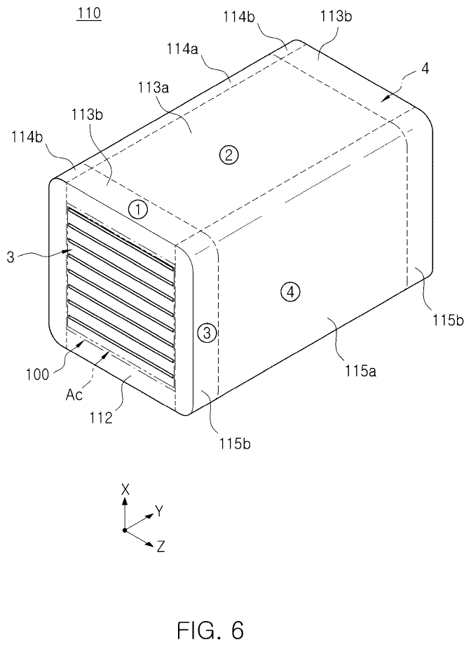

FIG. 6 schematically illustrates a perspective view of a body according to an embodiment.

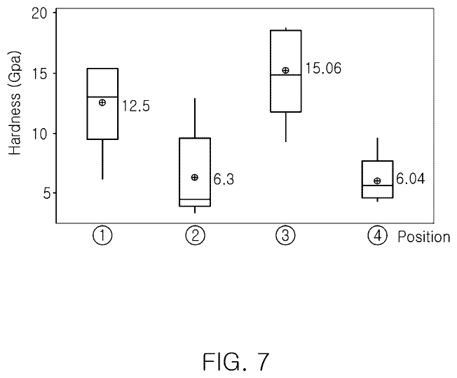

FIG. 7 is a graph showing the hardness of a cover portion and a side margin portion for each position according to an embodiment.

In the drawings, the X-direction may refer to the thickness direction, the Y-direction may refer to the length direction, and the Z-direction may refer to the width direction. The stacking direction of the internal electrode or dielectric layer may be the thickness direction or the width direction.

Hereinafter, a multilayer electronic component 1000 according to an embodiment and various embodiments thereof will be described in detail with reference to FIGS. 1 to 7.

The multilayer electronic component 1000 according to an embodiment may include a body 110 including a laminate 100 in which a dielectric layer 111 and internal electrodes 121 and 122 are stacked in a first direction, and cover portions 112 and 113 disposed on each of a plurality of surfaces of the laminate 100 opposing each other in the first direction, the body including a first surface and a second surface 1 and 2 opposing each other in the first direction, a third surface 3 and a fourth surface 4 connected to the first surface 1 and the second surface 2 and opposing each other in the second direction, and a fifth surface 5 and a sixth surface 6 connected to the first surface 1, the second surface 2, the third surface 3, and the fourth surface 4 and opposing each other in the third direction; and external electrodes 130 and 140 disposed on each of the third surface 3 and the fourth surface 4 and connected to the internal electrodes 121 and 122. The cover portions 112 and 113 may include second regions 113b adjacent to the third surface 3 or the fourth surface 4 and a first region 113a disposed between the second regions 113b, and the average hardness of the second region 113b may be greater than the average hardness of the first region 113a.

The multilayer electronic component 1000 according to an embodiment may include a body 110 including the laminate 100 in which a dielectric layer 111 and internal electrodes 121 and 122 are stacked in a first direction, and side margin portions 114 and 115 disposed on each of a plurality of surfaces of the laminate 100 opposing each other in a third direction, the body 110 including a first surface and a second surface 1 and 2 opposing each other in the first direction, a third surface 3 and a fourth surface 4 connected to the first surface 1 and the second surface 2 and opposing each other in the second direction, and a fifth surface 5 and a sixth surface 6 connected to the first surface 1, the second surface 2, the third surface 3, and the fourth surface 4 and opposing each other in the third direction; and external electrodes 130 and 140 disposed on each of the third surface 3 and the fourth surface 4 and connected to the internal electrodes 121 and 122. The side margin portions 114 and 115 may include fourth regions 114b and 115b adjacent to the third surface 3 or the fourth surface 4, and third regions 114a and 115a disposed between the fourth regions 114b and 115b, and the average hardness of the fourth regions 114b and 115b may be greater than the average hardness of the third regions 114a and 115a.

The body 110 may include the laminate 100 in which the dielectric layer 111 and the internal electrodes 121 and 122 are stacked in the first direction.

There is no particular limitation on the detailed shape of the body 110, but as illustrated in FIGS. 1 and 6, the body 110 may be formed in a hexahedral shape or a similar shape. Due to the shrinkage of the ceramic powder included in the body 110 during the firing process, the body 110 may not have a perfectly straight hexahedral shape, but may have a substantially hexahedral shape.

Referring to FIGS. 1 and 6, the body 110 may include a first surface 1 and a second surface 2 opposing each other in a first direction, a third surface 3 and a fourth surface 4 connected to the first surface 1 and the second surface 2 and opposing each other in a second direction, and a fifth surface 5 and a sixth surface 6 connected to the first surface 1, the second surface 2, the third surface 3, and the fourth surface 4 and opposing each other in a third direction.

Referring to FIGS. 2 and 3, the body 110 may include the laminate 100 in which the internal electrodes 121 and 122 and the dielectric layer 111 are stacked in the first direction. The laminate 100 may include a capacitance forming portion Ac, which is a region where the first internal electrode 121 and the second internal electrode 122 overlap in the first direction, and a region excluding the capacitance forming portion Ac.

The dielectric layer 111 forming the laminate 100 is in a sintered state, and the boundary between adjacent dielectric layers 111 may be so integrated that it is difficult to identify without a scanning electron microscope (SEM).

The raw material forming the dielectric layer 111 is not particularly limited as long as it may obtain sufficient capacitance. For example, a barium titanate-based material, a lead composite perovskite-based material, a strontium titanate-based material, or the like may be used. The barium titanate-based material may include BaTiO₃-based ceramic powder. Examples of the ceramic powder may include BaTiO₃, (Ba₁₋ₓCaₓ) TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1), in which calcium (Ca), zirconium (Zr) or the like is partially solubilized in BaTiO₃, and the like.

Furthermore, the raw material forming the dielectric layer 111 may include barium titanate (BaTiO₃) powder, to which various ceramic additives, organic solvents, binders, dispersants, or the like may be added, according to an aspect of the present disclosure.

An average thickness td of the dielectric layer 111 does not need to be specifically limited. For example, if miniaturization and high-capacitance of the multilayer electronic component 1000 are required, the average thickness td of the dielectric layer 111 may be 0.35 μm or less. If the reliability improvement of the multilayer electronic component 1000 under high temperature and high voltage is required, the average thickness td of the dielectric layer 111 may be 1 μm or more.

The average thickness td of the dielectric layer 111 may refer to the average thickness of one or more first dielectric layers in the first direction among a plurality of first dielectric layers.

The average thickness of the dielectric layer 111 in the first direction may be measured by scanning an image of the cross-section of the multilayer electronic component 1000 in the first and second directions using a scanning electron microscope (SEM) at 10,000× magnification. In more detail, the first-direction average thickness of a dielectric layer 111 may be an average value calculated by measuring the first-direction thicknesses of the dielectric layer 111 at four or more equally spaced points in the second direction in a scanned image. The four or more equally spaced points may be designated in the capacitance forming portions Ac. Furthermore, by extending this average value measurement to four or more dielectric layers 111, the first-direction average thickness of the dielectric layer 111 may be more generalized.

The internal electrodes 121 and 122 may be alternately disposed with the dielectric layer 111 in the first direction, and may include a first internal electrode 121 connected to a first external electrode 130 and a second internal electrode 122 connected to a second external electrode 140.

The first and second internal electrodes 121 and 122 may be electrically isolated from each other by a dielectric layer 111 disposed therebetween.

The material forming the internal electrodes 121 and 122 is not particularly limited, and any material with excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

Furthermore, the internal electrodes 121 and 122 may be formed by printing a conductive paste for internal electrodes, including at least one of nickel (Ni), copper (Cu), palladium (Pd), silver (Ag), gold (Au), platinum (Pt), tin (Sn), tungsten (W), titanium (Ti), and alloys thereof, onto a ceramic green sheet. The printing method for the conductive paste for the internal electrode may be screen printing or gravure printing, but the present disclosure is not limited thereto.

A thickness the of the internal electrodes 121 and 122 need not be particularly limited.

If miniaturization and high-capacitance of the multilayer electronic component 1000 are required, the average thickness the of the internal electrodes 121 and 122 may be 0.35 μm or less. If the reliability improvement of the multilayer electronic component 1000 under high temperature and high voltage is required, the average thickness the of the internal electrodes 121 and 122 may be 1 μm or more.

The average thickness the of the internal electrodes 121 and 122 may refer to the average thickness of one or more internal electrodes 121 and 122 in the first direction among the plurality of internal electrodes 121 and 122.

The first-direction average thickness of the internal electrodes 121 and 122 may be measured by scanning the first and second-direction cross section of the multilayer electronic component 1000 with a scanning electron microscope (SEM) at 10,000× magnification. In more detail, the first-direction average thickness of one internal electrode may be an average value calculated by measuring the first-direction thickness at four or more equally spaced points of one internal electrode in the second direction in the scanned image. The four or more equally spaced points may be designated in the capacitance forming portion Ac. In addition, by extending this average value measurement to four or more internal electrodes 121 and 122 and measuring the average value, the first-direction average thickness of the internal electrodes 121 and 122 may be more generalized.

Referring to FIGS. 2 and 3, cover portions 112 and 113 may be disposed on each of a plurality of surfaces of the laminate 100 opposing each other in the first direction. The cover portions 112 and 113 do not include internal electrodes 121 and 122 and may contain the same dielectric material as the dielectric layer 111, but their specific compositions may differ.

The average thickness tc of the cover portions 112 and 113 need not be specifically limited. However, to facilitate miniaturization and high-capacitance multilayer electronic components, the average thickness tc of the cover portions 112 and 113 may be 15 μm or less. In this case, the average thickness tc of the cover portions 112 and 113 may refer to the average thicknesses of the first cover portion 112 and the second cover portion 113, respectively.

The average thickness tc of the cover portions 112 and 113 may refer to the first direction size and may be the average of the first direction sizes of the cover portions 112 and 113 measured at five equally spaced points above or below the capacitance forming portion Ac.

Referring to FIG. 3, side margin portions 114 and 115 may be disposed on both surfaces of the laminate 100 in the third direction.

As illustrated in FIG. 3, the side margin portions 114 and 115 may refer to the area between the two ends of the first and second internal electrodes 121 and 122 and the boundary surface of the body 110 in a cross-section of the body 110 along the width-thickness (W-T) direction.

The side margin portions 114 and 115 may fundamentally serve to prevent damage to the internal electrodes due to physical or chemical stress.

To suppress the step difference caused by the internal electrodes 121 and 122, the side margin portions 114 and 115 may be formed by cutting the internal electrodes so that the internal electrodes are exposed on both surfaces of the laminate 100 opposing each other in the third direction and then by stacking a single dielectric layer or two or more dielectric layers on both side surfaces of the capacitance forming portion Ac in the width direction.

The width wm of the side margin portions 114 and 115 need not be specifically limited. However, to facilitate miniaturization and high-capacitance multilayer electronic components, the average width of the side margin portions 114 and 115 may be 15 μm or less.

The average width wm of the side margin portions 114 and 115 may refer to the average size of the side margin portions 114 and 115 in the third direction, and may be the average value of the third direction size of the side margin portions 114 and 115 measured at five equally spaced points on the side surface of the capacitance forming portion Ac.

The external electrodes 130 and 140 are disposed on the body 110.

The external electrodes 130 and 140 may be disposed on the third surface 3 and the fourth surface 4, which are surfaces facing the body 110 in the second direction perpendicular to the first direction, and may be connected to the internal electrodes 121 and 122. In detail, the first external electrode 130 may be connected to the first internal electrode 121 by being disposed on the third surface 3, which is one surface facing in the second direction perpendicular to the first direction of the body 110, and the second external electrode 140 may be connected to the second internal electrode 122 by being disposed on the fourth surface 4, which is the other surface facing in the second direction perpendicular to the first direction of the body 110.

Although this embodiment describes the structure of a multilayer electronic component 1000 having two external electrodes 130 and 140, the number and shape of the external electrodes 130 and 140 may vary depending on the shape of the internal electrodes 121 and 122 or other usages.

The external electrodes 130 and 140 may include electrode layers 131 and 141 in contact with the third surface 3 and the fourth surface 4, and plating layers 132 and 142 disposed on the electrode layers 131 and 141.

The electrode layers 131 and 141 may include a conductive metal. The conductive metal is not particularly limited as long as it may be electrically connected to the internal electrodes 121 and 122 to form capacitance. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof.

In more detail, the electrode layers 131 and 141 may be sintered electrodes including a conductive metal and glass, or resin-based electrodes including a conductive metal and resin.

Furthermore, the electrode layers 131 and 141 may be formed by sequentially forming sintered electrodes and resin-based electrodes on the body 110.

Additionally, the electrode layers 131 and 141 may be formed by transferring a sheet containing a conductive metal onto the body 110, or by transferring a sheet containing a conductive metal onto a sintered electrode.

The plating layers 132 and 142 may serve to improve mounting characteristics.

The type of plating layers 132 and 142 is not particularly limited, and the plating layers 132 and 142 may be plating layers of a single layer containing at least one of nickel (Ni), tin (Sn), silver (Ag), palladium (Pd), and alloys thereof, or may be formed of a plurality of layers.

In more detail, for example, the plating layers 132 and 142 may be nickel (Ni) plating layers or tin (Sn) plating layers, and may be in the form in which the nickel plating layer and the tin plating layer are sequentially formed on the electrode layers 131 and 141, or in the form in which the tin plating layer, nickel plating layer, and tin plating layer are sequentially formed. Furthermore, the plating layers 132 and 142 may include a plurality of nickel plating layers or a plurality of tin plating layers.

The size of the multilayer electronic component 1000 is not particularly limited.

However, to obtain miniaturization and high capacitance at the same time, the thickness of the dielectric layer and internal electrode should be thinned and the number of stacked layers thereof should be increased, and thus, the size thereof may be equal to or smaller than 1005 (length×width: 1.0 mm×0.5 mm, the error range of length and width is within ±5%) size and 0603 (length×width: 0.6 mm×0.3 mm, the error range of length and width is within ±5%) size.

In general, the cover portions 112 and 113 and the side margin portions 114 and 115 may be subjected to uneven stress in each region during the firing process, and as a result, the regions of the side margin portions 114 and 115 and the cover portions 112 and 113 adjacent to the surfaces 3 and 4 of the body 110 where the internal electrodes 121 and 122 are exposed may have reduced toughness, increasing the possibility of chipping occurring, and the chipping occurring in this way may cause a decrease in the moisture resistance reliability of the multilayer electronic component 1000.

Referring to FIGS. 6 and 7, positions \textcircled{1} and \textcircled{3} of the cover portions 112 and 113 and side margin portions 114 and 115, respectively, adjacent to the third surface 3 or fourth surface 4 of the body 110 where the internal electrodes 121 and 122 are exposed and chipping may frequently occur, may have hardness values at least 1.5 times greater than positions \textcircled{2} and \textcircled{4}, which are not adjacent to the third surface 3 and fourth surface 4. This difference in hardness may occur due to differences in shrinkage rates at different positions within the body 110, even when using a dielectric sheet with a uniform composition for forming the cover portions 112 and 113 or a sheet with a uniform composition for forming the side margin portions 114 and 115.

On the other hand, referring to FIGS. 4 and 6, in the multilayer electronic component 1000 according to an embodiment, the cover portions 112 and 113 include the second region 113b adjacent to the third surface or the fourth surface 4, and the first region 113a disposed between the second regions 113b, and the average hardness of the second regions 113b may be controlled to be higher than the average hardness of the first region 113a, thereby reducing the possibility of chipping occurring in the second region 113b of the cover portions 112 and 113, which is an area adjacent to the third surface 3 or the fourth surface 4 of the body 110 where the internal electrodes 121 and 122 are exposed, and improving the moisture resistance reliability of the multilayer electronic component 1000.

In addition, on the other hand, referring to FIGS. 5 and 6, in the multilayer electronic component 1000 according to an embodiment, the side margin portions 114 and 115 include fourth regions 114b and 115b adjacent to a third surface 3 or a fourth surface 4, and third regions 114a and 115a disposed between the fourth regions 114b and 115b, and the average hardness of the fourth regions 114b and 115b is controlled to be higher than the average hardness of the third regions 114a and 115a, thereby reducing the possibility of chipping occurring in the fourth regions 114b and 115b of the side margin portions 114 and 115, which is an area adjacent to the third surface 3 or the fourth surface 4 of the body 110 where the internal electrodes 121 and 122 are exposed, and improving the moisture resistance reliability of the multilayer electronic component 1000.

The effect of the present disclosure in reducing the frequency of chipping in the second region 113b of the cover portions 112 and 113 may be significant when the ratio of the average hardness of the second region 113b to the average hardness of the first region 113a of the cover portions 112 and 113 is less than 1.5. Meanwhile, the lower limit of the ratio of the average hardness of the second region 113b to the average hardness of the first region 113a of the cover portions 112 and 113 is not particularly limited and may exceed, for example, 1.0. For example, in an embodiment, the ratio of the average hardness of the second region 113b to the average hardness of the first region 113a of the cover portions 112 and 113 may be greater than 1.0 and less than 1.5, thereby reducing the frequency of chipping occurrence in the second region 113b of the cover portions 112 and 113, and thus, further improving the moisture resistance reliability of the multilayer electronic component 1000.

An example of a method for measuring an average hardness of each region of the cover portions 112 and 113 is as follows. However, the present disclosure is not limited to the measurement method described below.

First, the multilayer electronic component 1000 is polished in the first direction to the first surface 1 or the second surface 2 to expose the external surface of the cover portions 112 and 113. Then, an image of the external surface of the cover portions 112 and 113 is observed using an optical device such as an optical microscope. Using an image processing program, a point 1/10 to 3/20 from one end of the cover portions 112 and 113 in the second direction and a point 1/10 to 3/20 from the other end of the cover portions 112 and 113 in the second direction are designated as the second regions 113b, and the area disposed between the second regions 113b is designated as the first region 113a.

Thereafter, the average value of the hardness measurements taken at three or more equally spaced points in the second-direction upper portions and at three or more equally spaced points left and right in the third direction, based on the center of the first region 113a in the second and third directions, may be the average hardness of the first region 113a.

Also, the hardness of one second region 113b may be measured at three or more equally spaced points up and down in the second direction and at two or more equally spaced points left and right in the third direction, based on the center of the second region 113b in the second and third directions. These measurements may be repeated in another second region 113b, and the average value may then be calculated to obtain the average hardness value of the second region 113b.

Meanwhile, the hardness of each region of the cover portions 112 and 113 may be measured using equipment such as a micro-indenter or nano-indenter under the conditions of maximum load: 50 mN, maximum depth: 0.9 μm, loading-unloading rate: 300 mN/min, pause: 5 sec, tip: Berkovich, and temperature: 25° C., but the present disclosure is not limited thereto.

The second region 113b of the cover portions 112 and 113 is a region where chipping may occur intensively. Therefore, it may be desirable that the second region 113b not excessively occupy the entire area of the cover portions 112 and 113. In detail, the ratio of the average length LC1 of the second region 113b to the average length LC0 of the cover portions 112 and 113 in the second direction may be 0.15 or less. Meanwhile, because the second region 113b is adjacent to the third surface 3 or fourth surface 4 where the internal electrodes 121 and 122 are exposed, shrinkage force is applied during the firing process. Even if the second region 113b is formed to a minimum, there may be technical limitations in reducing the shrinkage force to zero. Accordingly, the ratio of the average length LC1 of the second region 113b to the average length LC0 of the cover portions 112 and 113 in the second direction may be 0.10 or more. For example, in an embodiment, the ratio of the average length LC1 of the second region 113b to the average length LC0 of the cover portions 112 and 113 in the second direction may be 0.10 or more and 0.15 or less.

The method for measuring the second-direction average length LC0 of the cover portions 112 and 113 is not particularly limited, and after the multilayer electronic component 1000 is polished in the first direction to the first surface 1 or the second surface 2 to expose the external surface of the cover portions 112 and 113, the external surface of the cover portions 112 and 113 is observed in an image obtained by using an optical device such as an optical microscope, and the second-direction length from one ends of the cover portions 112 and 113 in the second direction to the other ends may be measured using an image processing program or the like. When this measurement is performed at two or more points up and down in the third direction based on the center of the cover portions 112 and 113 in the third direction, and the average value is taken, the second-direction average length LC0 of the cover portions 112 and 113 may be measured. Meanwhile, the second-direction average length LC1 of the second region 113b may be the length measured in the second direction from one or the other end in the second direction. In this case, the average hardness of the second region 113b may have the same magnitude as in the previously described embodiment.

During the firing process of the body 110, the shrinkage force generated due to the difference in the degree of stacking of the internal electrodes 121 and 122 may be applied from the second-direction end to the entire third direction of the cover portions 112 and 113. Therefore, in an embodiment, by continuously disposing the second region 113b from one end of the laminate 100 in the third direction to the other end thereof in the third direction, the toughness against the shrinkage force applied from the second-direction end to the entire third direction of the cover portions 112 and 113 may be improved, thereby further reducing the frequency of chipping in the second region 113b.

In an embodiment, the second region 113b may be a region formed at both ends of the cover portions 112 and 113 in the second direction and thus may be a region in contact with the external electrodes 130 and 140.

Furthermore, the second region 113b may be disposed beyond the end of the internal electrodes 121 and 122 in the second direction. In detail, in an embodiment, a portion of the second region 113b may overlap with the capacitance forming portion Ac in the first direction.

In an embodiment, the ratio of the average hardness of the fourth regions 114b and 115b to the average hardness of the third regions 114a and 115a of the side margin portions 114 and 115 may be greater than 1.0 and less than 2.0.

The effect of the present disclosure in reducing the frequency of chipping occurrence in the fourth regions 114b and 115b the side margin portions 114 and 115 may be significant when the ratio of the average hardness of the fourth regions 114b and 115b to the average hardness of the third regions 114a and 115a of the side margin portions 114 and 115 is less than 2.0. Meanwhile, the lower limit of the ratio of the average hardness of the fourth regions 114b and 115b to the average hardness of the third regions 114a and 115a of the side margin portions 114 and 115 is not particularly limited and may exceed 1.0, for example. For example, in an embodiment, the ratio of the average hardness of the fourth regions 114b and 115b to the average hardness of the third regions 114a and 115a of the side margin portions 114 and 115 may be greater than 1.0 and less than 1.5. Accordingly, the frequency of chipping in the fourth regions 114b and 115b of the side margin portions 114 and 115 may be reduced, thereby further improving the moisture resistance reliability of the multilayer electronic component 1000.

An example of a method for measuring the average hardness of each region of the side margin portions 114 and 115 is as follows.

First, the multilayer electronic component 1000 is polished in the first direction to the fifth surface 5 or sixth surface 6 to expose the external surfaces of the side margin portions 114 and 115, and then, in an image of the external surface of the side margin portions 114 and 115 observed with an optical device such as an optical microscope, an image processing program is used to distinguish between fourth regions 114b and 115b designated for a point 1/10 to 3/20 in the second direction from one ends of the side margin portions 114 and 115 in the second direction and a point 1/10 to 3/20 in the second direction from the other ends of the side margin portions 114 and 115 in the second direction, and third regions 114a and 115a disposed between the fourth regions 114b and 115b.

Thereafter, the average value of the hardness measurements taken at three or more equally spaced points up and down in the first direction and at three or more equally spaced points left and right in the second direction, based on the center of the third regions 114a and 115a in the first and second directions, may be the average hardness of the third regions 114a and 115a.

Furthermore, the hardness may be measured at three or more equally spaced points up and down in the first direction and at two or more equally spaced points left and right in the second direction, based on the center of one fourth region 114b or 115b in the first and second directions. This measurement may be repeated in the other fourth region 114b or 115b, and the average value may then be obtained and may be the average hardness value of the fourth regions 114b and 115b.

Meanwhile, the area-specific hardness of the side margin portions 114 and 115 may be measured using equipment such as a micro indenter or nano indenter under the conditions of Max load: 50 mN, Max depth: 0.9 μm, Loading-unloading rate: 300 mN/min, Pause: 5 sec, Tip: Berkovich, and Temperature: 25° C., but the present disclosure is not limited thereto.

Because the fourth regions 114b and 115b of the side margin portions 114 and 115 are areas where chipping may occur intensively, it may be desirable that the second region 113b not excessively occupy the entire area of the side margin portions 114 and 115. In detail, the ratio of the average length LM1 of the fourth regions 114b and 115b to the second-direction average length LM0 of the side margin portions 114 and 115 may be 0.15 or less. Meanwhile, because the fourth regions 114b and 115b are adjacent to the third surface 3 or the fourth surface 4 where the internal electrodes 121 and 122 are exposed, shrinkage force is applied during the firing process, and even if the fourth regions 114b and 115b are formed to a minimum, there may be a technical limitation in making the shrinkage force 0. Accordingly, the ratio of the average length LM1 of the fourth regions 114b and 115b to the second-direction average length LM0 of the side margin portions 114 and 115 may be 0.10 or more. For example, in an embodiment, the ratio of the average length LM1 of the fourth regions 114b and 115b to the second-direction average length LM0 of the side margin portions 114 and 115 may be 0.10 or more and 0.15 or less.

The method for measuring the second-direction average length LM0 of the side margin portions 114 and 115 is not particularly limited, and after the multilayer electronic component 1000 is polished in the first direction to the fifth surface 5 or the sixth surface 6 to expose the external surfaces of the side margin portions 114 and 115, the external surfaces of the side margin portions 114 and 115 are observed in an image obtained by using an optical device such as an optical microscope, and the second-direction length from one end of the side margin portions 114 and 115 in the second direction to the other end may be measured using an image processing program, or the like. If this measurement is performed at two or more points above and below the first-direction center of the side margin portions 114 and 115 and then the average value is taken, the second-direction average length LM0 of the side margin portions 114 and 115 may be measured. Meanwhile, the second-direction average length LM1 of the fourth regions 114b and 115b may be the length measured in the second direction from one or the other end thereof in the second direction. In this case, the average hardness of the fourth regions 114b and 115b may have the same magnitude as in the previously described embodiment.

During the firing process of the body 110, the shrinkage force generated due to the difference in the stacking degree of the internal electrodes 121 and 122 may be applied from the second-direction ends of the side margin portions 114 and 115 to the entire first direction. Therefore, in an embodiment, by continuously disposing the fourth regions 114b and 115b from one end in the first direction to the other end in the first direction of the laminate 100, the toughness against the shrinkage force applied from the second-direction ends of the side margin portions 114 and 115 to the entire first direction may be improved, thereby further reducing the frequency of chipping in the fourth regions 114b and 115b.

In an embodiment, the fourth regions 114b and 115b may be regions formed at both ends of the side margin portions 114 and 115 in the second direction and thus may be regions in contact with the external electrodes 130 and 140.

In addition, the fourth regions 114b and 115b may be disposed beyond one ends of the internal electrodes 121 and 122 in the second direction.

In an embodiment, an example of a method for controlling the hardness of the cover portions 112 and 113 and the side margin portions 114 and 115 for each region may include forming low-hardness regions at both ends of the dielectric sheets forming the cover portions 112 and 113 and the side margin portions 114 and 115, and attaching and firing these dielectric sheets to the laminate 100. These low-hardness regions of the dielectric sheets may be formed by forming a dielectric sheet of the related art in the center and printing low-hardness dielectric sheets at both ends. Meanwhile, a dye may be added to the low-hardness regions, but such dye may volatilize during firing.

In an embodiment, the dielectric sheets used in the low-hardness regions and the high-hardness regions may have different sintering aid contents or different average dielectric particle diameters. Accordingly, after sintering of 1000, the average the multilayer electronic component dielectric grain sizes of respective regions of the cover portions 112 and 113 and the side margin portions 114 and 115 may be different. In this way, by making the average dielectric grain sizes of respective regions of the cover portions 112 and 113 and the side margin portions 114 and 115 different, the hardness of each region of the cover portions 112 and 113 and the side margin portions 114 and 115 may be adjusted differently, but the present disclosure is not limited thereto.

### Experimental Example

Table 1 below illustrates the evaluation of the frequency of chipping defects and moisture resistance reliability of samples, as in a multilayer electronic component 1000 according to an embodiment, which include a laminate 100 and cover portions 112 and 113, and in which the cover portions 112 and 113 include a second region 113b adjacent to the third or fourth surface 4 and a first region 113a disposed between the second regions 113b, and in which the ratio (H2/H1) of the average hardness H2 of the second region 113b to the average hardness H1 of the first region 113a is varied.

In addition, Table 2 below illustrates the evaluation of the chipping defect frequency and moisture resistance reliability in samples, as in a multilayer electronic component 1000 according to an embodiment, which include a laminate 100 and margin portions 114 and 115, and in which the side margin portions 114 and 115 include fourth regions 114b and 115b adjacent to the third surface or fourth surface 4, and third regions 114a and 115a disposed between the fourth regions 114b and 115b, and in which ratios (H4/H3) of the average hardness H4 of the fourth regions 114b and 115b to the average hardness H3 of the third regions 114a and 115a are different.

The average hardnesses H1, H2, H3, and H4 were determined by polishing the multilayer electronic component 1000 up to the first surface 1 in the first direction to expose the external surface of the cover portion 112, or polishing the same up to the fourth surface 4 in the second direction to expose the external surface of the margin portion 115, and by observing images with an optical microscope to distinguish respective regions using the ImageJ program. The method for distinguishing respective regions was as described above.

The average hardness H1 of the first region 113a is the average of the hardness values measured at three equally spaced points up and down in the second direction and at three equally spaced points left and right in the third direction, based on the center of the first region 113a in the second and third directions. The average hardness H2 of the second region 113b is the average of the hardness values measured at three equally spaced points up and down in the second direction and at two equally spaced points left and right in the third direction, based on the center of the second region 113b in the second and third directions. The average hardness H3 of the third regions 114a and 115a is the average of the hardness values measured at three equally spaced points up and down in the first direction and at three equally spaced points left and right in the second direction, based on the center of the third regions 114a and 115a in the first and second directions. The average hardness H4 of the fourth regions 114b and 115b is the average of the hardness values measured at three points equally spaced up and down in the first direction and at two points equally spaced left and right in the second direction, based on the center of the fourth regions 114b and 115b in the first and second directions.

For the chipping defect rate, it was determined as a defect if chipping was observed in the cover portion or margin portion among 1,200 samples per test number through appearance inspection.

The moisture reliability evaluation was conducted on 1, 200 samples per test number under the conditions below. A defect was determined if the insulation resistance value decreased to 106Ω or less.

(Moisture Reliability Evaluation Conditions): Temperature: 85° C., Relative humidity: 85%, Applied voltage: 9.45V, Voltage application time: 48 hours.

TABLE 1

| | | Chipping | Moisture |
|---|---|---|---|
| | | Occurrence | Resistance |
| | | Frequency | Reliability |
| Test | | (Number of | (Number of |
| Number | H2/H1 | Defects/Samples) | Defects/Samples) |
| 1 | 1.1 | 0/1200 | 0/1200 |
| 2 | 1.2 | 0/1200 | 0/1200 |
| 3 | 1.4 | 1/1200 | 0/1200 |
| 4 | 1.5 | 4/1200 | 3/1200 |
| 5 | 1.6 | 6/1200 | 4/1200 |
| 6 | 1.8 | 7/1200 | 6/1200 |
| 7 | 2.0 | 8/1200 | 6/1200 |

Referring to Table 1, for Test Nos. 4 to 7, where H2/H1 is 1.5 or more, the frequency of chipping defects increases and moisture resistance reliability decreases. On the other hand, for Test Nos. 1 to 3, where H2/H1 is less than 1.5, the frequency of chipping defects decreases and moisture resistance reliability is improved.

Therefore, as in an embodiment, it can be confirmed that, when the ratio of the average hardness of the second region 113b of the cover portions 112 and 113 to the average hardness of the first region 113a satisfies a range of greater than 1.0 and less than 1.5, the frequency of chipping defects of the multilayer electronic component 1000 may be reduced and the moisture resistance reliability may be improved.

TABLE 2

| | | Chipping | Moisture |
|---|---|---|---|
| | | Occurrence | Resistance |
| | | Frequency | Reliability |
| Test | | (Number of | (Number of |
| Number | H4/H3 | Defects/Samples) | Defects/Samples) |
| 8 | 1.3 | 0/1200 | 0/1200 |
| 9 | 1.6 | 0/1200 | 0/1200 |
| 10 | 1.8 | 1/1200 | 0/1200 |
| 11 | 1.9 | 2/1200 | 0/1200 |
| 12 | 2.0 | 5/1200 | 4/1200 |
| 13 | 2.1 | 6/1200 | 4/1200 |
| 14 | 2.4 | 8/1200 | 5/1200 |

Referring to Table 2, for test numbers 4 to 7, where H4/H3 is 2.0 or more, the frequency of chipping defects increases sharply and the moisture resistance reliability decreases sharply. On the other hand, it can be confirmed that for test numbers 1 to 3, where H4/H3 is less than 2.0, the frequency of chipping defects decreases and the moisture resistance reliability is improved.

Therefore, as in an embodiment, it can be confirmed that when the ratio of the average hardness of the fourth regions 114b and 115b of the side margin portions 114 and 115 to the average hardness of the third regions 114a and 115a satisfies a range of greater than 1.0 and less than 2.0, the frequency of chipping defects of the multilayer electronic component 1000 may be reduced and the moisture resistance reliability may be improved.

As set forth above, according to an embodiment, the moisture resistance reliability of multilayer electronic components may be improved by reducing the frequency of chipping in a region of the cover portion adjacent to a body surface where the internal electrode is exposed.

According to an embodiment, the moisture resistance reliability of multilayer electronic components may be improved by reducing the frequency of chipping in a region of the side margin portion adjacent to a body surface where the internal electrode is exposed.

While embodiments have been described in detail above, the present disclosure is not limited to the above-described embodiments and the attached drawings, but is intended to be defined by the appended claims. Therefore, those skilled in the art will that appreciate various substitutions, modifications, and alterations may be made without departing from the technical spirit of the present disclosure as defined in the claims, and such modifications are also within the scope of the present disclosure.

Furthermore, the term “an embodiment” used herein does not imply identical embodiments, and rather, is provided to emphasize and explain the unique features of each embodiment. However, the presented embodiments do not preclude implementation in combination with features of other embodiments. For example, even if a description in a specific embodiment is not described in another embodiment, it can be understood as relating to another embodiment, unless otherwise described in another embodiment, which is contrary to or contradicts the description.

The terminology used in this disclosure is solely for describing an embodiment and is not intended to limit the present disclosure. In this case, singular expressions include plural expressions unless the context clearly indicates otherwise.

While example embodiments have been shown and described above, it will be apparent to those skilled in the art that modifications and variations could be made without departing from the scope of the present disclosure as defined by the appended claims.

What is claimed is:

1. A multilayer electronic component comprising:
a body including a laminate in which a dielectric layer and an internal electrode are stacked in a first direction, and a cover portion disposed on each of a plurality of surfaces of the laminate opposing each other in the first direction, the body including a first surface and a second surface opposing each other in the first direction, a third surface and a fourth surface connected to the first surface and the second surface and opposing each other in a second direction, and a fifth surface and a sixth surface connected to the first surface, the second surface, the third surface, and the fourth surface and opposing each other in a third direction; and
an external electrode disposed on each of the third surface and the fourth surface and connected to the internal electrode,
wherein the cover portion includes second regions adjacent to the third surface or the fourth surface, and a first region disposed between the second regions, and
an average hardness of the second regions is greater than an average hardness of the first region.

2. The multilayer electronic component of claim 1, wherein a ratio of the average hardness of the second regions to the average hardness of the first region is greater than 1.0 and less than 1.5.

3. The multilayer electronic component of claim 1, wherein a ratio of an average length of the second regions to an average length of the cover portion in the second direction is 0.10 or more and 0.15 or less.

4. The multilayer electronic component of claim 1, wherein the second regions are continuously disposed from one end of the laminate in the third direction to the other end in the third direction.

5. The multilayer electronic component of claim 1, wherein the second regions are in contact with the external electrode.

6. The multilayer electronic component of claim 1, wherein the internal electrode includes a first internal electrode connected to the third surface and a second internal electrode connected to the fourth surface,
the laminate includes a capacitance forming portion, which is a region in which the first internal electrode and the second internal electrode overlap in the first direction, and
portions of the second regions overlap the capacitance forming portion in the first direction.

7. The multilayer electronic component of claim 1, wherein the body further includes a side margin portion disposed on each of the surfaces of the laminate opposing each other in the third direction,
wherein the side margin portion includes fourth regions adjacent to the third surface or the fourth surface, and a third region disposed between the fourth regions, and
an average hardness of the fourth regions is greater than an average hardness of the third region.

8. The multilayer electronic component of claim 7, wherein a ratio of the average hardness of the fourth regions to the average hardness of the third region is greater than 1 and less than 2.0.

9. The multilayer electronic component of claim 7, wherein a ratio of an average length of the fourth regions in the second direction to an average length of the side margin portion in the second direction is 0.10 or more and 0.15 or less.

10. The multilayer electronic component of claim 7, wherein the fourth regions are continuously disposed from one end of the laminate in the first direction to the other end in the first direction.

11. The multilayer electronic component of claim 7, wherein the fourth regions are in contact with the external electrode.

12. A multilayer electronic component comprising:
a body including a laminate in which a dielectric layer and an internal electrode are stacked in a first direction, and a side margin portion disposed on each of a plurality of surfaces of the laminate opposing each other in a third direction, the body including a first surface and a second surface opposing each other in the first direction, a third surface and a fourth surface connected to the first surface and the second surface and opposing each other in a second direction, and a fifth surface and a sixth surface connected to the first surface, the second surface, the third surface, and the fourth surface and opposing each other in the third direction; and
an external electrode disposed on each of the third surface and the fourth surface and connected to the internal electrode,
wherein the side margin portion includes fourth regions adjacent to the third surface or the fourth surface, and a third region disposed between the fourth regions, and
a ratio of an average hardness of the fourth regions to an average hardness of the third region is greater than 1.0 and less than 2.0.

13. The multilayer electronic component of claim 12, wherein a ratio of an average length of the fourth regions to an average length of the side margin portion in the second direction is 0.10 or more and 0.15 or less.

14. The multilayer electronic component of claim 12, wherein the fourth regions are continuously disposed from one end of the laminate in the first direction to the other end in the first direction.

15. The multilayer electronic component of claim 12, wherein the fourth regions are in contact with the external electrode.
